(19) United States
(12) Patent Application Publication
(10) Pub. No.: US 2025/0200379 A1
(43) Pub. Date: Jun. 19, 2025

(54) HIERARCHICAL REINFORCEMENT LEARNING AT SCALE

(71) Applicant: DeepMind Technologies Limited, London (GB)

(72) Inventors: Hubert Josef Soyer, London (GB); Feryal Behbahani, London (GB); Thomas Albert Keck, London (GB); Kyriacos Nikiforou, Strovolo (CY); Bernardo Avila Pires, London (GB); Satinder Singh Baveja, Ann Arbor, MI (US)

(21) Appl. No.: 18/846,329

(22) PCT Filed: Jun. 7, 2023
(86) PCT No.: PCT/EP2023/065305

§ 371 Date: Sep. 12, 2024

Related U.S. Application Data
(60) Provisional application No. 63/349,968, filed on Jun. 7, 2022.

(51) Int. Cl. G06N 3/092

(52) U.S. Cl. CPC G06N 3/092

(57) ABSTRACT

The invention describes a system and a method for controlling an agent interacting with an environment to perform a task, the method comprising, at each of a plurality of first time steps from a plurality of time steps: receiving an observation characterizing a state of the environment at the first time step; determining a goal representation for the first time step that characterizes a goal state of the environment to be reached by the agent; processing the observation and the goal representation using a low-level controller neural network to generate a low-level policy output that defines an action to be performed by the agent in response to the observation, wherein the low-level controller neural network comprises: a representation neural network configured to process the observation to generate an internal state representation of the observation, and a low-level policy head configured to process the state observation representation and the goal representation to generate the low-level policy output; and controlling the agent using the low-level policy output.

### CROSS-REFERENCE TO RELATED APPLICATION

This application claims priority to U.S. Provisional Application No. 63/349,968, filed on Jun. 7, 2023. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that controls an agent interacting with an environment to perform a task in the environment.

At each time step, the agent receives an input observation and performs an action from a set of actions. For example, the set of actions can include a fixed number of actions or can be a continuous action space.

Generally, the system controls the agent using a hierarchical controller. The hierarchical controller includes a low-level controller neural network and a high-level controller neural network.

The hierarchical controller generates options that can be used to control the agent. Generally, an option is a generalization of an action. For example, options can include any of actions (as specified above), high-level actions that impact the hierarchical controller's selection of actions, goal outputs (“goal options”) that characterizes a goal state of the environment to be reached by the agent, and other generalizable behaviors.

This specification also describes goal-conditioning techniques for training the low-level controller neural network and the high-level controller neural network so that the hierarchical controller can be used to effectively control the agent using goal representations that are generated from goal outputs produced by the high-level controller neural network.

Particular embodiments of the subject matter described in this specification can be implemented so as to realize one or more of the following advantages.

Unlike existing hierarchical agents, the hierarchical system described in this specification is able to demonstrate performance comparable to or exceeding that of other flat (non-hierarchical) techniques on challenging, real-world tasks, e.g., visually complex partially observable 3D environments.

Additionally, the described system can train a hierarchical controller to learn goal-conditioned behaviors from any experience gathered through the training process of the low-level controller, the high-level controller, or both. This represents an advancement in the field of goal-conditioned reinforcement learning, which has historically relied on expert-generated data within the environment to train an agent on goal representations.

This specification also describes techniques for training the low-level controller on multiple tasks at once, which increases the hierarchical controller's ability to generalize across tasks. This provides a concrete example of the potential abstraction, transfer, and skill reuse capabilities that are hallmarks of hierarchical reinforcement learning in difficult environments.

Furthermore, this specification describes techniques that allow a hierarchical controller to be used “at scale,” i.e., to be trained for and effectively used for large-scale, industrial tasks and, in some cases, to be able to generalize to new industrial tasks that were not encountered during the training of the low-level controller, the high-level controller, or both.

To use the hierarchical controller to effectively control the agent, this specification describes a variety of techniques that can be used together or separately to improve agent performance in such complex environments.

In an example method described herein, a method for controlling an agent interacting with an environment to perform a task comprises, at each of a plurality of first time steps from a plurality of time steps: receiving an observation characterizing a state of the environment at the first time step; determining a goal representation for the first time step that characterizes a goal state of the environment to be reached by the agent; processing the observation and the goal representation using a low-level controller neural network to generate a low-level policy output that defines an action to be performed by the agent in response to the observation. The low-level controller neural network comprises: a representation neural network configured to process the observation to generate an internal state representation of the observation, and a low-level policy head configured to process the state observation representation and the goal representation to generate the low-level policy output. The method comprises controlling the agent using the low-level policy output.

Determining the goal representation for the first time step that characterizes a goal state of the environment to be reached by the agent may comprise determining whether criteria for generating a new goal representation are satisfied at the first time step. When the criteria are not satisfied, the method may use, as the goal representation for the first time step, a goal representation from a preceding first time step. In one example implementation, when the criteria are satisfied, the method may include generating a high-level observation for the first time step; processing a high-level input that comprises the high-level observation using a high-level controller neural network to generate a high-level policy output that comprises a goal output characterizing the goal state; and processing the goal output using a goal encoder neural network to generate the goal representation. The high-level policy output may further comprise an indication of whether to (i) control the agent using the low-level controller or (ii) control the agent using a primitive action identified by the high-level policy output. In one example implementation, determining the goal representation for the first time step, processing the observation and the goal representation using the low-level controller neural network, and controlling the agent using the low-level policy output may be performed only in response to determining, based on the indication, to control the agent using the low-level controller. The method may further comprise, at each of one or more second time steps from the plurality of time steps: generating a high-level observation for the second time step; processing a high-level observation for the second time step using the high-level controller neural network to generate a high-level policy output for the second time step; determining, based on the indication of whether to (i) control the agent using the low-level controller or (ii) control the agent using a primitive action identified by the high-level policy output, to control the agent using the primitive action identified by the high-level policy output; and in response, controlling the agent using the primitive action identified by the high-level policy output.

The high-level observation for the first time step may comprise the observation received at the first time step. The high-level observation for the first time step may comprise data identifying a number of time steps since a most recent time step at which the criteria were satisfied. The high-level observation for the first time step may comprise data characterizing rewards received from the environment since a most recent time step at which the criteria were satisfied. The high-level observation for the first time step may comprise data characterizing observations received at time steps since a most recent time step at which the criteria were satisfied. The criteria may be satisfied when any criterion in a set of criteria are satisfied. The high-level observation for the time step may comprise data identifying which criterion was satisfied at the first time step.

The goal output characterizing the goal state may be a goal vector characterizing the goal state. The goal output characterizing the goal state may be a text sequence describing the goal state. The high-level policy output may comprise a hyperparameter that defines some aspect of training. Controlling the agent using the low-level policy output may comprise: applying the hyperparameter to the low-level policy output to generate an adjusted policy output; and selecting an action using the adjusted policy output. The high-level policy may use a temperature parameter as the hyperparameter to adjust the low-level policy output.

Determining whether criteria for generating a new goal representation are satisfied at the first time step may comprise: determining that the criteria for generating a new goal representation are satisfied when the first time step is an initial time step in a task episode. Determining whether criteria for generating a new goal representation are satisfied at the first may comprise determining that a maximum number of time steps have elapsed since a most recent time step at which the criteria were satisfied.

The low-level controller neural network may further comprise a value head configured to process the observation representation and the goal representation to generate a value estimate of a value of the environment being in the state characterized by the observation to reaching the goal state characterized by the goal representation. Determining whether criteria for generating a new goal representation are satisfied at the first time steps may comprise: determining that the criteria for generating a new goal representation are satisfied when the value estimate generated by the value head by processing an observation representation of an observation at a preceding time step and a goal representation for the preceding time step is below an unreachability threshold value.

Determining whether criteria for generating a new goal representation are satisfied at the first time steps may comprise determining that the criteria for generating a new goal representation are satisfied when the value estimate generated by the value head by processing an observation representation of an observation at a preceding time step and a goal representation for the preceding time step is above an attained threshold value that indicates that the goal characterized by the goal representation for the preceding time step has been attained. The attained threshold value may be included in the high-level policy output.

Determining whether criteria for generating a new goal representation are satisfied at the first time steps may comprise: processing a classifier input characterizing (i) an observation at a preceding time step and (ii) a goal state for the preceding time step using a classifier neural network to generate a classifier output that indicates how many time steps remain until the goal state is attained; and determining that the criteria for generating a new goal representation are satisfied when the classification output indicates that zero time steps remain until the goal state is attained.

In another example method described herein, a method of training the low-level controller neural network comprises: obtaining one or more trajectories of observation-action pairs and, for each trajectory, a respective goal; for each trajectory, generating a respective reward for each pair in the trajectory based on whether the goal was attained in the state characterized by the observation in the pair; and training the low-level controller neural network on the one or more trajectories and the one or more rewards to optimize a reinforcement learning objective that comprises a proximity regularization term that penalizes low-level policy outputs generated by the low-level controller neural network from diverging from behavior cloning policy outputs generated by a behavior cloning head that is (i) trained on a behavior cloning loss and (ii) configured to, for a given observation and given goal representation, process a given observation representation for the given observation generated by the representation neural network and the given goal representation to generate a behavior cloning policy output for the observation.

The behavior cloning policy outputs and the low-level policy outputs may each define a probability distribution over actions. The proximity regularization term may be based on, for each observation in each trajectory, a divergence between (i) a low-level policy output generated by the low-level policy head by processing an observation representation of the observation generated by the representation neural network and a goal representation of the goal for the trajectory and (ii) a behavior cloning policy output generated by the behavior cloning policy head by processing the observation representation of the observation generated by the representation neural network and the goal representation of the goal for the trajectory. For example, the divergence may be a KL divergence. The reinforcement learning objective may further comprise a term that, for each observation-action pair in each trajectory, is a product of (i) a term that is based on the reward for the pair and (ii) a ratio between (a) a probability assigned to the action in the pair by the low-level policy output generated by the low-level policy head by processing an observation representation of the observation generated by the representation neural network and a goal representation of the goal for the trajectory and (b) a probability assigned to the action in the pair by the behavior cloning policy output generated by the behavior cloning policy head by processing the observation representation of the observation generated by the representation neural network and the goal representation of the goal for the trajectory. For example, the term that is based on the reward for the pair may be a V-Trace policy gradient term.

The method can further comprise training the behavior cloning policy head on the one or more trajectories to minimize the behavior cloning loss.

For one or more of the trajectories, the goal may be an image of the environment in a goal state. The training may further comprise processing the image using an image goal encoder neural network to generate a goal representation to be processed by the low-level policy head and the behavior cloning policy head. For one or more of the trajectories, the goal may be text describing a goal state of the environment. The training may further comprise processing the text using a text goal encoder neural network to generate a goal representation to be processed by the low-level policy head and the behavior cloning policy head.

The one or more trajectories may be sampled from off-line data generated while the agent was controlled by one or more different behavior policies. The low-level controller may be trained only on the off-line data.

Alternatively, the low-level controller may be trained both on the off-line data and on-line data generated by controlling the agent using both high-level policy outputs generated by the high-level controller and low-level policy outputs generated by the low-level controller.

The method may further comprise training the high-level controller neural network through reinforcement learning to maximize expected rewards for the task generated as a result of controlling the agent based on high-level policy outputs generated by the high-level controller neural network and low-level policy outputs generated by the low-level controller neural network. In some example implementations, no gradients are passed to the low-level controller neural network as a result of the training of the high-level controller neural network.

The one or more trajectories may include one or more on-line trajectories that generated while controlling the agent during the training of the high-level controller or low-level controller. In alternative implementations, the one or more trajectories do not include any on-line data generated while controlling the agent during the training of the high-level controller.

The reinforcement learning objective may comprise one or more auxiliary loss terms. Each auxiliary loss term may correspond to a respective auxiliary task. Each of the auxiliary tasks may require generating a prediction characterizing a distribution of goals conditioned on an output generated by the representation neural network.

The method may further comprise generating, for each of the one or more trajectories of observation-action pairs, a respective goal. The generating may comprise, for one or more of the trajectories, selecting a goal describing a state of the environment characterized by the last observation in the trajectory.

The method may further comprise generating, for each of the one or more trajectories of observation-action pairs, a respective goal. The generating may comprise, for one or more of the trajectories, selecting a goal describing a state of the environment that is not characterized by any of the observations in the trajectory.

The agent may be a mechanical agent and the environment may be a real-world environment. For example, the agent may be a robot. The environment may be a real-world environment of a service facility comprising a plurality of items of electronic equipment and the agent is an electronic agent configured to control operation of the service facility. The environment may be a real-world manufacturing environment for manufacturing a product and the agent may comprise an electronic agent configured to control a manufacturing unit or a machine that operates to manufacture the product.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example action selection system.

FIG. 2A is a flow diagram of an example process for generating options for the hierarchical controller.

FIG. 2B shows how the high-level controller and low-level controller interact in more detail.

FIG. 3 depicts an example high-level controller and its components in greater detail.

FIG. 4 depicts an example low-level controller and its components in greater detail.

FIG. 5 demonstrates an example offline-online training system for the hierarchical controller.

FIG. 6 is a block diagram of an example process for hindsight selection of goal representations in the offline-online training system.

FIG. 7 shows the benchmarked performance of the described techniques relative to conventional techniques.

FIG. 8 depicts the importance of having a proximity regularization penalty.

Like reference numbers and designations in the various drawings indicate like elements.

### DETAILED DESCRIPTION

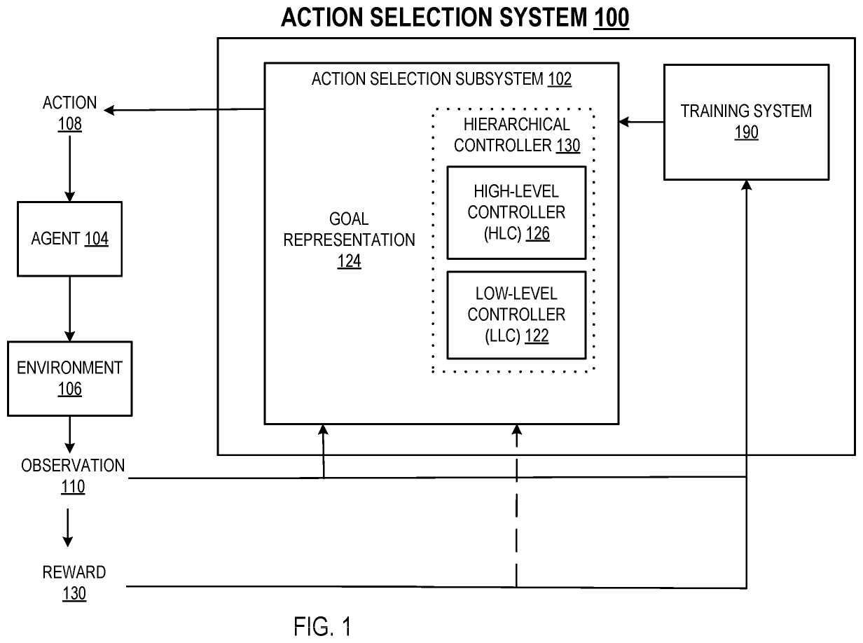

FIG. 1 shows an example action selection system 100. The action selection system 100 is an example of a system implemented as computer programs on one or more computers in one or more locations in which the systems, components, and techniques described below are implemented.

The action selection system 100 controls an agent 104 interacting with an environment 106 to accomplish a task by selecting actions 108 to be performed by the agent 104 at each of multiple time steps during the performance of an episode of the task.

As a general example, the task can include one or more of, e.g., navigating to a specified location in the environment 106, identifying a specific object in the environment 106, manipulating the specific object in a specified way, controlling items of equipment to satisfy criteria, distributing resources across devices, and so on. More generally, the task is specified by received rewards 130, i.e., such that an episodic return is maximized when the task is successfully completed. Rewards and returns will be described in more detail below. Examples of agents, tasks, and environments are also provided below.

An “episode” of a task is a sequence of interactions during which the agent 104 attempts to perform a single instance of the task starting from some starting state of the environment 106. In other words, each task episode begins with the environment 106 being in an initial state, e.g., a fixed initial state or a randomly selected initial state, and ends when the agent 104 has successfully completed the task or when some termination criterion is satisfied, e.g., the environment 106 enters a state that has been designated as a terminal state or the agent 104 performs a threshold number of actions 108 without successfully completing the task.

At each time step during any given task episode, the system 100 receives an observation 110 characterizing the current state of the environment 106 at the time step and, in response, selects an action 108 to be performed by the agent 104 at the time step. After the agent 104 performs the action 108, the environment 106 transitions into a new state and the system 100 receives a reward 130 from the environment 106.

Generally, the reward 130 is a scalar numerical value and characterizes the progress of the agent 104 towards completing the task.

As a particular example, the reward 130 can be a sparse binary reward that is zero unless the task is successfully completed as a result of the action being performed, i.e., is only non-zero, e.g., equal to one, if the task is successfully completed as a result of the action performed.

As another particular example, the reward 130 can be a dense reward that measures a progress of the agent towards completing the task as of individual observations received during the episode of attempting to perform the task, i.e., so that non-zero rewards can be and frequently are received before the task is successfully completed.

While performing any given task episode, the system 100 selects actions 108 in order to attempt to maximize a return that is received over the course of the task episode.

That is, at each time step during the episode, the system 100 selects actions 108 that attempt to maximize the return that will be received for the remainder of the task episode starting from the time step.

Generally, at any given time step, the return that will be received is a combination of the rewards that will be received at time steps that are after the given time step in the episode. For example, at a time step t, the return can satisfy:

$${\sum }_{i} {γ}^{i - t - 1} {r}_{i} ,$$

where i ranges either over all of the time steps after t in the episode or for some fixed number of time steps after t within the episode, γ is a discount factor that is greater than zero and less than or equal to one, and r¿ is the reward at time step i.

To control the agent 108, at each time step in the episode, an action selection subsystem 102 of the system 100 uses a hierarchical controller 130 to process an observation 110 to select the action 108 to be performed by the agent 104 at the time step.

The hierarchical controller 130 includes a high-level controller (HLC) 126 and a low-level controller (LLC) 122.

The LLC 122 is a neural network that is configured to receive an input that includes an observation 110 and a goal output that characterizes a goal state of the environment 106 to be reached by the agent 104 when interacting with the environment 106, which is processed into a goal representation (“goal”) 124. The LLC processes the inputs to generate a low-level output that defines an action 108 to be performed by the agent 104 in response to the observation 110 conditioned by the goal representation 124.

The HLC 126 is a neural network that is configured to process a high-level input to generate a high-level policy output that includes the goal option output.

In some implementations, the high-level policy output includes only the goal output.

In some other implementations, the high-level policy output includes additional data.

As a particular example, the high-level policy output can also identify a primitive action.

Primitive actions can be used to advance the system between goals 124 or generate training data for the low-level controller. In this case, the high-level policy output includes an indication of whether to (i) control the agent using the low-level controller or (ii) control the agent using the primitive action identified by the high-level policy output.

As another particular example, the high-level policy output can also identify a high-level action that changes how a policy-output is processed to select an action. In particular, this can be done to aid agent exploration during training.

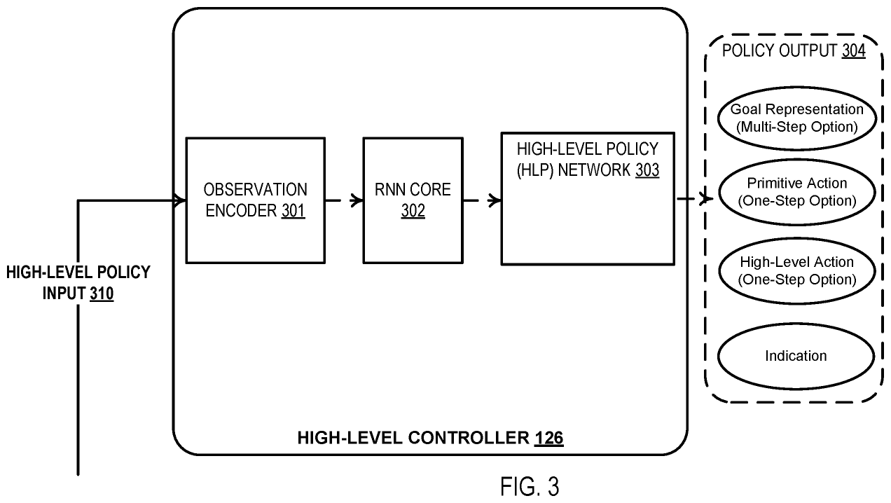

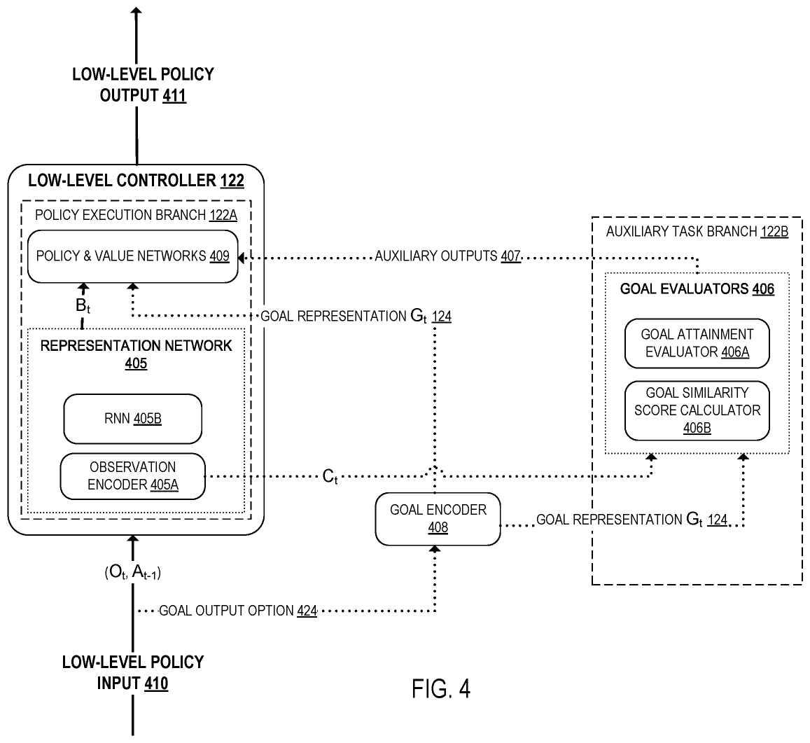

The components of the HLC neural network 126 are depicted in FIG. 3, and the components of the LLC neural network 122 are depicted in FIG. 4.

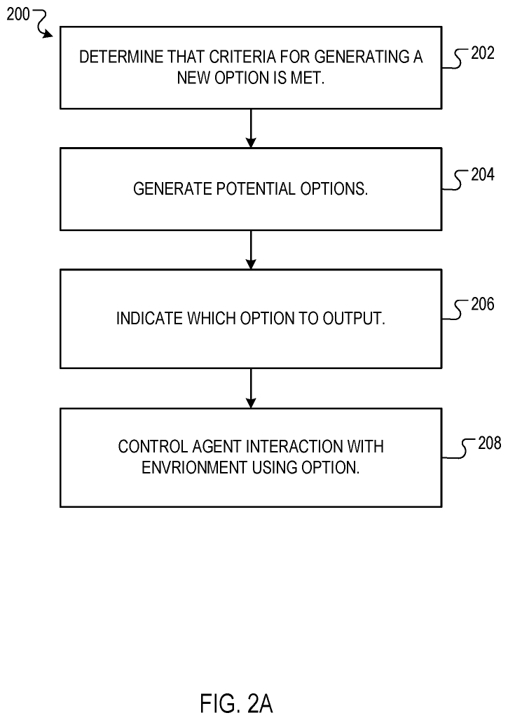

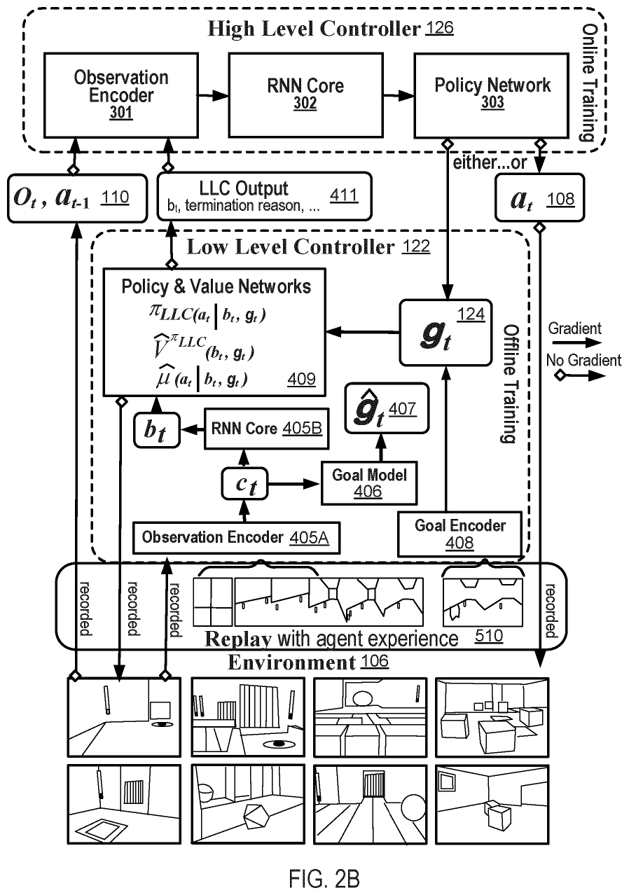

To use the controller 130 to select an action 108 at a given time step during an episode, the system determines whether criteria for generating a new option are satisfied at the time step. Determining whether criteria are satisfied is described in more detail below in FIG. 2A.

In some cases when the criteria are not satisfied, the system can use, as the goal 124 for the time step, the goal representation 124 from a preceding time step in the episode.

The system then uses the LLC neural network 122 to select the action 108 conditioned on the goal representation 124.

If the criteria are satisfied, the system uses the HLC neural network 126 to generate a high-level policy output.

In implementations where the high-level policy output includes only the goal output, the system uses the goal output to generate a new goal representation 124 and uses the new goal representation as the goal representation for the time step. The system then uses the LLC neural network 122 to select the action 108 conditioned on the goal representation 124.

In implementations where the high-level policy output also indicates whether to (i) control the agent using the LLC 122 or (ii) control the agent using the primitive action identified by the high-level policy output, the hierarchical controller 130 can use either the HLC 126 or the LLC 122 policy output to select the action 108 to be performed by the agent 104 at the time step based on the indication.

If the controller 130 determines to control the agent using the LLC 122, the controller 130 uses the goal output to generate a new goal representation 124 and uses the new goal representation as the goal representation for the time step. The system then uses the LLC neural network 122 to select the action 108 conditioned on the goal representation 124.

If the controller 130 determines to control the agent using the HLC 126, the controller 130 selects the primitive action from the high-level output as the action 108 for the time step.

In some cases, the HLC 126 can output a successive sequence of primitive actions to advance the system before selecting a new goal output.

In a particular example, at any given step in the episode, the action selection subsystem 102 can use the HLC 126 to process the observation 110 to generate a goal output that is sent to the LLC 122 to be processed into a goal representation 124. Time steps at which the HLC 126 generates a goal output that is used to generate a goal representation 124 and time steps at which the LLC 122 acts using a goal representation 124 will be referred to as “first time steps” in this specification.

In this example, the LLC 122 can then process the observation 110 to generate a policy output conditioned on the goal representation 124. The system 100 can then use the policy output to select an action 108.

Furthermore, at another time step in the episode, the low-level controller 110 can take the observation 110 received after the first action 108 and send it to the high-level controller 126 in the form of a high-level input.

In some examples, this high-level input can include a high-level observation that summarizes the agent's 104 actions 108 in the environment 108 since the last time the HLC 126 provided a goal output used to generate a goal representation 124. The criteria for generating a new goal representation will be discussed in FIG. 2A.

The high-level controller 126 can process this high-level input to generate a high-level policy output characterizing whether to control the agent 104 using the LLC 122 with the goal output that is processed into a goal representation 124 in successive time steps.

At some time steps, the action selection subsystem 102 can use the HLC 126 to process the high-level input and generate a primitive action option that uses the high-level policy output to control the agent 104 in the environment 106. That is, a “primitive action” is one of the actions from the set or space of actions that can be performed by the agent, and is referred to as “primitive” because it is generated as part or defined by the high-level policy output. Time steps at which the HLC generates a primitive action option will be referred to as “second time steps” in this specification.

As another example, at some time steps, the action selection subsystem 102 can use the high-level controller 126 to generate a high-level action option that changes how an action is selected from a policy-output. Examples of high-level action options will be covered in more depth in FIG. 3.

Thus, the agent executes under options provided by the hierarchical controller., i.e., the option can specify to select the action directly, change how the action is selected, or provide a goal output that the low-level controller 122 processes into a goal representation 124 to control the agent 104.

Potential criteria for generating options with the hierarchical controller will be covered in more detail in FIG. 2A.

The controllers 122, 126 can either use the same or different methods to process the policy output into an action 108. As discussed below within the context of potential processing methods, “the policy output” can refer to either the low-level controller policy output or, when used, the part of the high-level output that can identify a primitive action.

In one example, the policy output may include a respective numerical probability value for each action in the fixed set. The system 102 can select the action 108, e.g., by sampling an action in accordance with the probability values for the action indices, or by selecting the action with the highest probability value.

In another example, the policy output may include a respective Q-value for each action in the fixed set. The system 102 can process the Q-values (e.g., using a soft-max function) to generate a respective probability value for each action, which can be used to select the action 108 (as described earlier), or can select the action with the highest Q-value.

The Q-value for an action is an estimate of a return that would result from the agent 104 performing the action 108 in response to the current observation 110 and thereafter selecting future actions 108 performed by the agent 104 in accordance with current values of the parameters of the controllers 122, 126.

As another example, when the action space is continuous, the policy output can include parameters of a probability distribution over the continuous action space and the system 102 can select the action 108 by sampling from the probability distribution or by selecting the mean action. A continuous action space is one that contains an uncountable number of actions, i.e., where each action is represented as a vector having one or more dimensions and, for each dimension, the action vector can take any value that is within the range for the dimension and the only constraint is the precision of the numerical format used by the system 100.

As yet another example, when the action space is continuous the policy output can include a regressed action, i.e., a regressed vector representing an action from the continuous space, and the system 102 can select the regressed action as the action 108.

Prior to using the controllers 122, 126 to control the agent, a training system 190 within the system 100 or another training system can train the controllers 122, 126.

Specifically, the training system 190 can train the HLC 126 to select goal options that direct the LLC's 122 interactions with the environment 106 to cause the agent to effectively perform tasks and train the LLC 122 to effectively select actions given a goal representation.

Training the hierarchical controller 130 using the training system 190 will be discussed in more detail below with reference to FIG. 2A.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements, e.g., steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation, e.g., steering, and movement e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material, e.g., to remove pollutants, to generate a cleaned or recycled product. The manufacturing plant may comprise a plurality of manufacturing units such as vessels for chemical or biological substances, or machines, e.g., robots, for processing solid or other materials. The manufacturing units are configured such that an intermediate version or component of the product is moveable between the manufacturing units during manufacture of the product, e.g., via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g., minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment, e.g., between the manufacturing units or machines. In general the actions may be any actions that have an effect on the observed state of the environment, e.g., actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g., a metric of a quantity of energy, materials, or other resources, used to perform the task. In the case of a task that is to control use a resource the matric may comprise any metric of usage of the resource.

In another example, the agent may be a human or animal agent and controlling the agent may comprise outputting instructions or signals configured to cause the agent to perform an action. For example, instructions or signals may be output to the agent using an output device such as a display device, a speaker, or a haptic device. In this case, the task may be a task in a real-world environment, which may be any real-world environment including the examples described above. In some implementations user may be a user of a digital assistant such as a smart speaker, smart display, or other device. Then the digital assistant can be used to instruct the user to perform actions. For example, controlling the agent may comprise instructing the digital assistant to output to the human user, via the digital assistant, instructions for actions for the user to perform at each of a plurality of time steps. The instructions may for example be generated in the form of natural language, e.g. transmitted as sound and/or as text on a screen, based on actions chosen by the reinforcement learning system. The actions may be chosen such that they contribute to performing the task. An observation capture subsystem, e.g. a monitoring system such as a video camera or sound capture system, may be provided to capture visual and/or audio observations of the user performing a task. This can be used for monitoring the action, if any, which the user actually performs at each time step and to provide the observations characterizing the state of the environment.

In some of the implementations described above the environment may include a human being or animal. For example, the agent may be an autonomous vehicle in an environment which is a location where there are human beings, e.g. pedestrians or drivers/passengers of other vehicles and/or animals, or the autonomous vehicle itself may contain human beings. As another example the environment may include at least one room, e.g. in a habitation, containing one or more people. The human being or animal may be an element of the environment which is involved in the task.

In a further example the environment may comprise a human user who interacts with an agent which is in the form of an item of user equipment, e.g. a computer, mobile device, or digital assistant. The item of user equipment provides a user interface between the user and a computer system, which may be the same computer system(s) which implement the controllers, or a different computer system. The user interface may allow the user to enter data into and/or receive data from the computer system, and the agent may be controlled by the controllers to perform an information transfer task in relation to the user, such as providing information about a topic to the user and/or allowing the user to specify a component of a task which the computer system is to perform. For example, the information transfer task may be to teach the user a skill, such as how to speak a language or how to navigate around a geographical location. As another example the task may be to allow the user to define a three-dimensional shape to the computer system, e.g. so that the computer system can control an additive manufacturing (3D printing) system to produce an object having the shape. Actions may comprise outputting information to the user, e.g. in a certain format, at a certain rate, etc., and/or configuring the interface to receive input from the user. For example, an action may comprise setting a problem for a user to perform relating to the skill, e.g. asking the user to choose between multiple options for correct usage of the language, or asking the user to speak a passage of the language out loud, and/or receiving input from the user, e.g. registering selection of one of the options, or using a microphone to record the spoken passage of the language.

In general observations of a state of the environment may comprise any electronic signals representing the functioning of electronic and/or mechanical items of equipment. For example a representation of the state of the environment may be derived from observations made by sensors sensing a state of the manufacturing environment, e.g., sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions, e.g., a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g., data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control, e.g., cooling equipment, or air flow control or air conditioning equipment. The task may comprise a task to control, e.g., minimize, use of a resource, such as a task to control electrical power consumption, or water consumption. The agent may comprise an electronic agent configured to control operation of the items of equipment, or to control operation of the ancillary, e.g., environmental, control equipment.

In general the actions may be any actions that have an effect on the observed state of the environment, e.g., actions configured to adjust any of the sensed parameters described below. These may include actions to control, or to impose operating conditions on, the items of equipment or the ancillary control equipment, e.g., actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g., minimize, use of a resource, such as a task to control use of electrical power or water, the metric may comprise any metric of use of the resource.

In some implementations the environment is the real-world environment of a power generation facility, e.g., a renewable power generation facility such as a solar farm or wind farm. The task may comprise a control task to control power generated by the facility, e.g., to control the delivery of electrical power to a power distribution grid, e.g., to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements, e.g., to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g., an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid, e.g., from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmaceutically active compound and the agent is a computer system for determining elements of the pharmaceutically active compound and/or a synthetic pathway for the pharmaceutically active compound. The drug/synthesis may be designed based on a reward derived from a target for the drug, for example in simulation. As another example, the agent may be a mechanical agent that performs or controls synthesis of the drug.

In some further applications, the environment is a real-world environment and the agent manages distribution of tasks across computing resources, e.g., on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g., an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e., observations of a mechanical shape or of an electrical, mechanical, or electro-mechanical configuration of the entity, or observations of parameters or properties of the entity. The actions may comprise actions that modify the entity, e.g., that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g., in the form of computer executable instructions for manufacturing the entity. The process may include making the entity according to the design. Thus a design an entity may be optimized, e.g., by reinforcement learning, and then the optimized design output for manufacturing the entity, e.g., as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

Optionally, in any of the above implementations, the observation at any given time step may include data from a previous time step that may be beneficial in characterizing the environment, e.g., the action performed at the previous time step, the reward received at the previous time step, or both.

FIG. 2A is a flow diagram of an example process 200 of the goal representation training subsystem for the hierarchical controller that depicts how new options are generated by the high-level controller. For convenience, the process 200 will be described as being performed by a system of one or more computers located in one or more locations. For example, an action selection system, e.g., the action selection system 100 of FIG. 1, appropriately programmed in accordance with this specification, can perform the process 200.

The system can perform the process 200 at certain time steps during a sequence of time steps within an episode, e.g., at each time step when certain criteria for generating a new option are met (step 202).

The criteria for generating a new option can also be referred to as the criteria for generating a new goal representation.

The set of criteria can include one or more of a variety of criteria. Some specific criteria that can be included in a set of one or more criteria will now be described.

As an example, these criteria can be that the previous option has been executed.

For example, when the previous option was the primitive action, the system can determine that criteria are satisfied at the immediately following time step (even if none of the other criteria described below are satisfied).

As another example, the system can determine that the criteria are satisfied when the goal represented by the current goal representation has been achieved (or attained). Example techniques for determining when the current goal has been achieved are described in more detail below.

As another example, these criteria for generating new options can entail the same termination criteria that denote the end of a task episode. Specifically, they can correspond with the end of an episode in which the task was completed, i.e. the goal specified by the previous goal representation was met, or a certain threshold number of steps were met while trying to achieve the task.

As another example, these criteria can prescribe a new option at every N environment time steps, wherein N is an integer greater than or equal to one.

As another example, these criteria can be based on metrics that correspond with goal attainment, such determining whether it is possible to attain the specified goal representation in a discrete number of future time steps from the state of the environment at the current time step. That is, the criteria can be satisfied when the system determines that it is not possible to attain the goal represented by the current goal representation within the discrete number of future time steps.

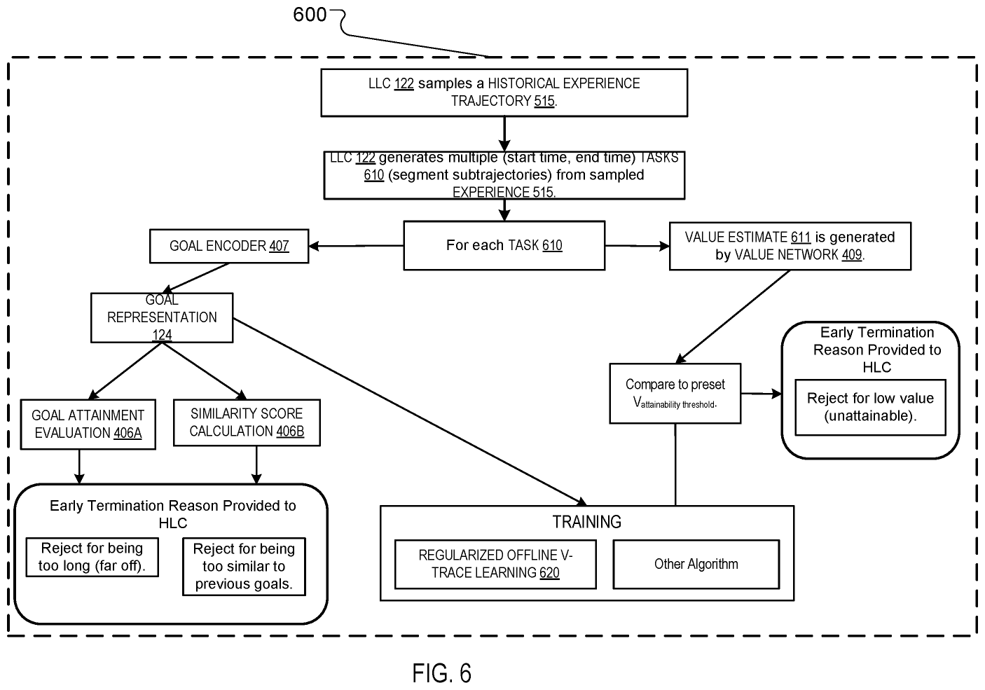

In some examples, goal attainability can be determined by comparing a value estimate provided by the low-level controller with a threshold. If the value estimate is higher than an attained threshold value, this indicates that the goal characterized by the goal representation has been achieved. If the value estimate is below an unreachability threshold, this indicates that the goal representation is not achievable within a select number of time steps. These value thresholds will be discussed in more detail below in FIGS. 4 and 6.

In some other examples, auxiliary calculations, such as logic-based systems or learnable methods, like networks or linear mappings trained to classify whether or not the goal is attainable within a set number of future steps, can be used to determine goal unattainability as of the current time step. These auxiliary calculations will be covered in more detail in FIG. 4. In the event of determined goal unattainability, agent execution under the chosen goal representation can be terminated early.

After the determination that criteria for generating the new option are met, the system generates the new option using the high-level controller (step 204).

The high-level controller output can include one or more types of options, including one-step or multi-step options, as well as criteria for selecting between them.

In certain examples, the output can include only goal options. Goal options are multi-step options that characterize a goal state of the environment to be reached by the agent. Goal options can be represented as text, image, or any other type of data that can represent a goal for the agent to achieve.

In particular, the goal option can include short text describing a goal state, such as “ball on table”.

In another particular example, the goal option can include an image that characterizes a goal state, such as an image that shows the ball on the table.

In some other examples, the output can include other option types.

In certain examples, the output can include primitive actions: one-step options that control the agent directly in the environment using the high-level policy output to select an action for the agent.

In another example, the output can include high-level actions: one-step options that can set the criteria for option termination, e.g. a maximum option duration threshold, or affect how the hierarchical controller selects actions, such as by applying noise or a function to the policy-output being used to select agent actions. In some examples, the low-level policy-output is affected by these high-level actions.

In a particular example that allows more than one type of option, the high-level controller output can also include an indication for selecting the type of option it outputs at that time step (step 206).

Specifically, the high-level policy output can include an indication of whether to (i) control the agent using the low-level controller or (ii) control the agent using a primitive action identified by the high-level policy output.

In this case, the high-level controller can use a learned model or a logic-based rules system to determine which option to choose.

In some examples, the indication of which output to select can be determined using a learned multi-class classification.

In particular, the high-level controller can include a high-level option decision network that is trained to output an option probability distribution used to select between the multiple option classes. In this case, either the highest probability option can be selected or the option can be sampled from the distribution.

As an example, the high-level controller can generate a goal option, a primitive option, and a high-level action and determine to: (i) output a goal option that the low-level controller can process into a goal representation to generate a policy output that controls the agent's actions with respect to this goal; (ii) output a one-step primitive action that dictates to directly select an action for the agent using the high-level policy; (iii) output a high-level action that can change how the action is determined from the low-level policy-output.

Once the option is generated, the system controls the agent's interaction with the environment using the new option (step 208).

For example, the system can select a goal option and use the low-level policy to process the goal option into a goal representation and then select the action conditioned on the goal representation.

In this case, the high-level controller can determine, at successive time steps, to reuse the multi-step goal option from the previous step until the above criteria are satisfied. This decision effectively yields control of the agent to the low-level controller for a number of time steps until the goal is determined to be achieved or unattainable, in which case a new goal representation or another option can be generated as detailed above. As another example, the system can select a primitive action and then directly use the high-level policy to select the action 108.

As yet another example, the system can select a high-level action and use the high-level action to change the threshold for option termination.

As yet another example, the system can select a high-level action and use the high-level action to change how actions 108 are selected by the low-level policy output.

In certain cases, this change can only impact the selection of one action.

In other cases, this high-level action imparts a lasting or irreversible change to how the low-level policy output selects actions.

In particular, the high-level action might prescribe a parameter that affects exploration over successive time steps until another high-level action sets a new parameter.

For example, the high-level action might specify a change to a temperature parameter t that is used in a temperature-dependent softmax equation. This type of high-level action will be covered in further detail in FIG. 3.

The system continues performing the process 200 until a fixed number of iterations for training the hierarchical controller are met or until termination criteria for the training of the hierarchical controller are satisfied, e.g., until the task has been successfully performed, until the environment reaches a designated termination state, or until a maximum number of time steps have elapsed during the episode.

FIG. 2B shows how the HLC 126 and LLC 122 interact in more detail.

The HLC 126 includes an observation encoder 301, RNN core 302, and policy network 303. These components are will be described in more detail with reference to FIG. 3.

The LLC 122 includes a goal encoder 408, an observation encoder 405A, one or more goal models 406, an RNN core 405B, and policy and value networks 409. These components will be described in more detail with reference to FIG. 4.

In this example, the HLC 126 outputs either a goal option to the LLC 122 or a primitive action that interacts directly with the environment 106, i.e., is directly used as an action to be performed by the agent 104 in the environment 106.

In the case where the HLC 126 outputs a goal option to the LLC 122, the goal option is processed into a goal representation 124 used to condition the LLC 122 policy outputs. The LLC 122 controls the agent 104 in the environment 106 under this goal representation 124 until the criteria covered in FIG. 2A are met.

In this particular case, when the criteria are met, the LLC 122 can generate a summarized experience output that serves as the HLC 126 input. This summarized output is used to guide the HLC 126 to select future goal options for the LLC 122 and will be covered in further detail in FIG. 4. That is, the LLC 122 generates an input to the HLC 126 that summarizes the agent's interactions with the environment since the previous time that the HLC 126 generated a goal output.

In certain examples, this summarized output can include goal representation 124 termination reasons. This will be covered in further detail in FIG. 6.

In the case where the HLC 126 output a primitive action, the HLC 126 controls the agent 104 in the environment 106 to take this action 108.

In this particular case, the criteria of FIG. 2A can be met directly after the action 108 is taken. The HLC 126 can process an observation 110 input to generate a new option output, as covered in FIG. 3.

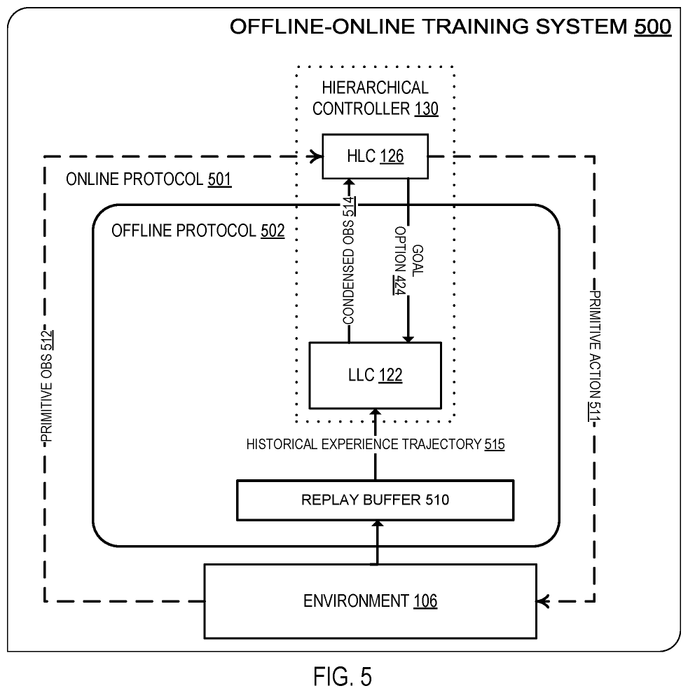

The replay buffer 510 depicted here is used by the training system 190 to perform an online-offline training protocol for the HLC 126 and LLC 122 and will be covered in more detail in FIG. 5. As part of this training, the goal models 406 (“goal predictors”) can be used to generate auxiliary predictions 407 that can improve the training.

FIG. 3 depicts an example HLC 126 and its components in greater detail.

At any given time step at which the HLC 126 is used, the HLC 126 receives a high-level policy input 310.

As an example, the input 310 can be an observation 110 that comes directly from the environment. For example, the input 310 can be the observation received at the given time step.

As another example, the input 310 can be a high-level observation provided by the LLC 122.

In a particular example, the LLC 122 can provide the series of observations 110 collected while trying to attain the goal representation 124 over a number of times steps to the HLC 126.

In another example, the LLC can condense or summarize the series of observations into a high-level observation.

In a particular example, this high-level observation can be created using element-wise averaging over this series of observations.

In other examples, this high-level observation can be created by encoding the series of observations by running the series of observations through a recurrent neural network (RNN) or another appropriate type of machine learning model.

Thus, the high-level input summarizes the interactions of the agent with the environment since the previous time that the criteria described with reference to FIG. 2B were satisfied.

As another example, this high-level input can include additional contextual information.

For example, the high-level input can include data identifying a number of time steps since the most recent goal option was generated, i.e., the current duration of the executed option, data characterizing rewards received from the environment during this time, and data identifying which criterion for generating a new option was satisfied at this time step.

In some instances, this criterion for generating a new option can be comparing a value estimate from the LLC 122 that pertains to the goal representation 124 to a threshold.

In particular, if below an unreachability threshold, the goal might be terminated early, in which case a new goal is needed.

Likewise, if above an attainability threshold, the goal is considered achieved and a new goal 124 is needed.

Possible other reasons for early termination will be described below with reference to FIG. 6.

In the example of FIG. 3, the high-level policy input 310 is first processed with a neural network that processes the input into an observation representation.

In certain cases, this neural network is an encoder. Encoders are models that generate an encoded representation of an input, meaning they transform input information into a latent space: a defined fixed-shape but different-dimensioned output.

In particular, an observation encoder neural network 301 can be used to encode the input 310. In this case, the observation encoder 301 takes in the input 310 and outputs an observation latent space representation.

This encoded output is then passed to a recurrent neural network (RNN) core 302.

The RNN core 302 can be a long short-term memory (LSTM) network, stacked LSTM, a gated recurrent unit (GRU) or any other variant of a recurrent neural network.

In other examples, this RNN 302 may be replaced by a Transformer model.

The output of the RNN 302 is then passed to the high-level policy network 303.

The high-level policy network 303 processes the output of the RNN 302 to generate the high-level policy output

In some examples with more than one option, the high-level policy network 303 can include one or more option encoders 303A—trained to embed potential options—and a high-level option decision network 303B—trained to provide the indication for which option to use—to generate the high-level policy output 304.

In particular, there can be one option encoder per type of option available to be selected by the HLC 126.

In certain examples, the options available for HLC output 304 can be limited, by regularizing or constraining the latent output of the option encoders 303A.

An option encoder 303A functions in a similar way to the observation encoder 301. The option encoder 303A processes the observation representation forwarded by the RNN 302 to generate an option latent space representation that pertains to the type of option it encodes for.

For example, in the case of one option encoder per type of option, there may be a goal option encoder and a primitive action encoder.

The various components of the HLC 126 can be learned together using reinforcement learning, i.e., to maximize expected rewards 130 that measure the performance of the neural network in controlling the agent 104 on a given task. In this case, gradients are passed between subnetwork components during the learning process.

As a particular example, the HLC 122 can be trained following an online Muesli protocol, which incorporates metrics from high-level policy network 303A learning as an additional loss in the reinforcement learning process.

More specifically, the Muesli protocol provides flexibility in the output of both continuous (multi-step) and discrete options (one-step) that can be used to control the low-level controller 122.

This high-level policy output 304 can include any number of different types of options as well as an indication for deciding between them.

In certain examples, the policy output 304 can include only a goal output option subcomponent.

In other examples, the policy output 304 can include a goal output option subcomponent, a primitive action subcomponent option, and a binary indication of which option to choose at that time step provided by the high-level option decision network 303B.

In this particular case, the binary indication will decide whether the HLC 126 will execute a primitive action in the environment 106 directly, or control the LLC neural network 122 to select the action 108 conditioned on the goal output returned in the output 304 which is processed into a goal representation 124.

In further examples, the policy output 304 can additionally include a high-level action option. In this case, the indication of which option to choose is a multi-class indication of which option to choose at that time step provided by the high-level option decision network 303B.

In particular, a high-level action can encompass actions taken by the HLC 126 to further control the LLC 122 selection of actions.

As an example, the high-level action might include a parameter that adjusts the LLC 122 policy output z.

In particular, the high-level action can specify a change to a temperature parameter τ that is used in a temperature-dependent softmax equation as defined by

$$σ = \frac{{e}^{{z ( i )}_{{/}_{τ}}}}{\sum j {e}^{{z ( j )}_{{/}_{τ}}}} ,$$

where z(i) is a score for action i in the low-level policy output and the sum is over the actions j in the set of actions that can be performed by the agent. Thus, the addition of a temperature parameter τ to the arguments of the exponent in the standard softmax equation produces different probability distributions over the potential set of actions.

Thus, in this example, when there are multiple possible options, the high-level controller 130 or more generally the action selection system 100 can parse the high-level policy output to determine, based on the indication, which option to select at any given time step.

While not depicted in this example, the HLC 126 can instead be implemented as large language model (LLM) neural network, e.g., a text based LLM neural network or a visual language model (VLM) neural network that receives both images and text as input. The LLM can be either pretrained or finetuned and can take in the high-level policy input 310 and output the high-level policy output 304 as a natural language instruction. That is, in this example, the high-level policy output can specify the goal as natural language text or, when the primitive action is to be performed, can specify the primitive action as one or more text tokens.

In particular, the HLC 126-LLM can process an example text high-level policy input 310 to generate the output 304. As another example, the HLC 126-VLM can process an example image high-level policy input 310 or an example high-level policy input that includes both images and text to generate the output 304. As a further example, a multimodal Transformer-based HLC 126 can be implemented to process and generate other input 310 or output 304 data modalities.

FIG. 4 depicts an example low-level controller 122 and its components in greater detail. This figure separates policy execution 122A from auxiliary tasks 122B into separate branches to provide a full overview of the LLC's 122 functioning during both (i) policy execution 122a to choose actions 108 and (ii) during training, which involves both policy execution 122A and auxiliary tasks 122B.

During training, both the policy execution branch 122A and the auxiliary task branch 122B run together, passing information as shown by the dotted lines in FIG. 4, to update the parameters of the policy and value networks 409, which include the policy and value heads using the auxiliary outputs 407.

The policy head includes one or more policy neural networks trained to learn the probability of actions to be taken for the observation 110 at that time step.

The value head includes one or more value neural networks trained to learn the value of the observation 110 at that time step. The value of the observation 110 at the time step represents the value of the environment being in the state characterized by the observation to reaching the goal state characterized by the goal representation. That is, the value is a score that represents the value of the environment being in the state characterized by the observation to reaching the goal state characterized by the goal representation.

After training, only the policy execution branch 122A functions—without the auxiliary task branch 122B since no parameter updates are necessary—to produce the low-level policy output, as shown by the solid lines in FIG. 4.

As described above, in some implementations, the criteria for generating a new goal representation can include one or more criteria that depend on goal attainability, goal unreachability, or both. In this case, goal attainability or unreachability can be determined using thresholds that correspond to the value output.

The LLC 122 receives and encodes a low-level policy input 410 that can include an option, such as a goal option 424 or a high-level action, and an observation-action pair that includes the data from the current time step Oₜ and the previous action Aₜ₋₁.

This input 410 can either come directly from the environment 106 in online training or after training; or from sampling from observations 110 logged in a replay buffer in offline training.

In the case of sampling from a replay buffer during offline training, the LLC 122 can select and encode its own goal representations 124 using hindsight selection of goals. This process will be covered in more depth in FIG. 6.

In the case of a goal option 424 as input 410 during training or an option proposed by the HLC after training, a goal encoder 408 within the auxiliary task branch 122B encodes the received goal 124 into a latent goal space as an embedded goal representation Gt 124.

Embedding the goal into a latent space enables the goal encoder 207 to be agnostic to goal-type. This setup enables the use of any goal modality given an encoder can be trained from the goal to the shared embedded space of goals.

The goal representation Gt 124 can be represented with text, image, or any other type of data that can be embedded into the shared goal space.

In certain examples, the goal encoder may be an autoencoder-like network that outputs the parameters of a multivariate normal distribution with diagonal covariance as the shared embedded space of goals. The system can then sample the goal representation 124 from this multivariate normal distribution.

The goal representation Gt 124 can be used as an input to the policy and value networks 409.

In the case of an observation, which, in this case example, includes data from the current time step and the previous action as input 410, the pair is passed through a representation network 405 that generates an observation representation Bt used in the training of the policy and value networks 409.

In certain examples, the representation network 405 can include an observation encoder 405A and an RNN 405B that generates the observation representation Bt.

This observation encoder 405A can be a similar or different architecture from the observation encoder 301 described above in FIG. 3's depiction of the HLC 126, but maintains the same function.

Likewise, this RNN 405B can be a similar or different architecture from the RNN 302 described above in FIG. 3's depiction of the HLC 126, but maintains the same function.

The policy execution branch 122A contains the policy and value networks 409 which are trained to prescribe high-value actions 108 for the agent 104 to take in the environment 106.

The policy and value networks 409 include a low-level target policy μ_{LLC}, low-level behavior policy π_{LLC}, and value estimator V^{LLC}.

The low-level target policy μ_{LLC} is a policy that is trained to learn the goal-conditioned probability distribution over actions using rewards 130 received for actions 108. This policy is trained with behavior cloning from offline data to serve as an expert policy that can improve the effectiveness of training the behavior policy π_{LLC} through offline reinforcement learning. In other words, the system trains the low-level target policy through behavior cloning on trajectories from an offline data set, e.g., the same data set used to train the behavior policy or a different offline data set.

The behavior policy π_{LLC} is the policy that is configured to process a given observation 110 and goal representation 124 to generate a policy output that can select actions for the agent.

In some examples, the behavior policy output can be affected by high-level options that change how the action 108 is selected from the behavior policy output.

In particular, while training π_{LLC}, the system uses the behavior cloned trained target policy μ_{LLC} to regularize the training of π_{LLC}.

Specifically, a proximity regularization term may be incorporated in the loss function of the behavior policy to train π_{LLC}.

In some examples, this proximity regularization term can be based on the divergence between π_{LLC} and μ_{LLC}.

After training, this can yield a behavior policy π_{LLC} that is able to select actions 108 in accordance with the goal-conditioned probability distribution over actions.

The value estimator V^{LLC} generates a value V^{LLC} for the observation 110 that is based on learning an expected cumulative reward for that observation 110 over successive time steps, where the reward at a given time step represents whether the current goal was attained at the time step. For example, the system can train the value estimator using a regression loss relative to ground truth values for the time steps.

The behavior policy π_{LLC} can be trained using any appropriate actor-critic method.

In particular, the behavior policy π_{LLC} can be trained offline with the IMPALA (Importance Weighted Actor-Learner Architecture) protocol (Espeholt et al., arXiv:1802.01561), which can be scaled using distributed computing to consist of one or more decoupled learners.

Additionally, IMPALA incorporates the use of a V-Trace term to train π_{LLC} and correct for the discrepancy of policy lag in offline configurations with multiple learners.

In particular, the behavior policy π_{LLC} can be optimized by following the V-Trace policy gradient.

The V-Trace term is a product of (i) an advantage term (advantage estimate) that is based on the reward 130 for the observation-action pair as compared to the average of actions that could have been taken given that observation 110 and (ii) a ratio between (a) a probability assigned to the action 108 aₜ in the pair by the low-level policy head μ_{LLC} by processing an observation representation bₜ of the observation 110 and (ii) a probability \hat{μ} assigned to the action 108 in the pair by the behavior cloning policy output generated by the behavior cloning policy head μ_{LLC} by processing the observation representation bₜ and the embedded goal representation g 124 of the goal for the trajectory. This term can be represented as:

$$\frac{{π}_{LLC} ( {a}_{t} \vert {b}_{t} , g )}{\hat{μ} ( {a}_{t} \vert {b}_{t} , g )} \cdot {Adv}_{t} \cdot ∇ log {π}_{LLC} ( {a}_{t} \vert {b}_{t} , g )$$

where Advₜ is an advantage estimate at time t computed using V-Trace returns and the value estimate for time step t. This is described in more detail in (Espeholt et al., arXiv:1802.01561.

In particular, the total loss can include the V-Trace term above and a regularization term weighted by a hyperparameter a to penalize the discrepancy between π_{LLC} and the target policy μ_{LLC} using KL divergence:

$$\begin{matrix}\frac{{π}_{LLC} ( {a}_{t} \vert {b}_{t} , g )}{\hat{μ} ( {a}_{t} \vert {b}_{t} , g )} \cdot {Adv}_{t} \cdot ∇ log {π}_{LLC} ( {a}_{t} \vert {b}_{t} , g ) \\ - α ∇ KL ( {π}_{LLC} ( {b}_{t} , g ) \vert \hat{μ} ( {b}_{t} , g ) ) ,\end{matrix}$$

Within the modified V-Trace algorithm, the gradients can be taken only with respect to the parameters of π_{LLC}.

That is, the system can train the components of the low-level controller offline using the above loss.

The auxiliary task branch 122B can also contain goal predictors 406 to increase LLC 122 performance with respect to the goal representation 124.

In the auxiliary task branch 122B, the output of the observation encoder 405A Ct can be forwarded to a set of goal evaluators 406, which use the intermediate observation representation Cₜ and the embedded goal representation Gₜ 124 to evaluate the goal 124 in question.

These goal predictors 406 can be, but are not limited to, learned mappings, such as neural networks or other functions and metrics that can be used to evaluate goal attainability and goal utility with respect to goals previously trained on.

In certain examples, the goal predictors 406 can include a goal attainment evaluator 406A that predicts whether or not the goal 124 is attainable within a predefined integer number of steps greater than or equal to one.

In other examples, the predictors 406 can include a goal similarity score calculator 406B that rejects goals 124 that are too similar to goals trained on before using a high-dimensional vector distance criteria.

In some examples, this high-dimensional vector distance criteria can be a cosine similarity metric.

The auxiliary outputs 407 of the goal evaluators 406 can serve as auxiliary tasks for the training of the policy execution branch 122A. This means that the outputs 407 can also be used as additional losses when training the policy and value networks 109.

When training is finished, these auxiliary tasks are no longer needed. In this case, goal attainment is determined by the value network, i.e., the value estimate is used to determine when to generate a new goal option.

Specifically, the criteria for generating a new goal representation are satisfied when the value estimate generated by the value head 409 by processing the observation representation and a goal representation 124 for the preceding time step is above an attained threshold value that indicates that the goal 124 for the preceding time step has been attained.

Likewise, the criteria for generating a new goal representation 124 are satisfied when the value estimate generated by the value head 409 by processing the observation representation and a goal representation 124 for the preceding time step is below an unreachability threshold that indicates that the goal 124 for the preceding time step will not be achieved in a discrete number of time steps.

FIG. 5 depicts an example training system 190, specifically an offline-online training system 500 that can be used to train the hierarchical controller 130 to perform a new task on uncurated data, i.e., data collected throughout the training process with policies of varying competency.

In such a system, the HLC 126 is trained online via an online protocol 501 (represented here by the dashed arrows) and the LLC 122 is trained offline via an offline protocol 502 (contained here in the solid rounded box). Training online means the HLC (126) is trained with an online dataset, e.g. its network gradients are updated after receiving immediate feedback in the form of the next observation 110 and reward 130 from time t+1 directly after it acts with the environment 106 or the condensed observation 124 it receives from the LLC 122 in time t. Training offline means the LLC (122) is trained with an offline dataset, e.g. its network gradients are updated via a sampling of past observations which are logged in a replay buffer 510.

Here the replay buffer 510 can be any data structure that can contain experience objects. For example, the replay buffer 510 can store a set of a historical experience trajectory objects 515.

Each trajectory object 515 might be a sequence of observation-action pairs, that were collected as a result of the interaction of the agent 104 with the environment 106 while controlled using a different policy, including policies of varying competence.

As an example, the different policy might be a fixed control policy, an already-learned policy, or controlled by an expert, e.g., by a human user.

This offline-online training system 500 can train on uncurated data using hindsight selection of goals, which will be covered in further depth in FIG. 6.

In this particular example, the HLC 126 can output either a goal option 424 or a primitive action 511.

In the case of the HLC 126 output being a primitive action 511, the primitive action 511 bypasses the LLC 122 to interact directly with and advance the environment 106, resulting in a primitive observation 512.

In particular, the primitive observation 512 can include the next observation 110 and reward 130 from time t+1 directly after it acts with the environment 106 in time t.

As an example interaction, the HLC 126 can output a primitive action 511 only at the start and end of an episode.

As another example interaction, the HLC 126 might output a goal option 424 that bypasses the environment 106 and is sent to the LLC 122 directly. In this case, the goal option 424 is processed into a goal representation 124 that is used for training.

In yet another example, the hindsight selection of goals enables the training of the hierarchical controller 130 on any data pertaining to multiple goals in the replay buffer 510, specifically data that was not generated by an expert, and will be covered in more detail in FIG. 6.

At the conclusion of training, the LLC 122 can provide a condensed observation 514 to the HLC 126. In this case, the LLC 122 is responsible for what the HLC 126 observes from the environment.

The condensed observation 514 constitutes information the HLC 126 needs to decide which option to execute next, i.e., which option to indicate in the policy output 304.

This condensed observation 514 can include any one of the following: environment observations 110, early termination reasons, a compressed history of observations, or any other information that suffices to summarize the LLC 122's interactions with the environment 106 during offline training 502.

As an example interaction, over the course of a single episode: the HLC 126 might receive the LLC's 122 initial observation 110 at the start of the episode and output a primitive action 511. Upon receiving the primitive online observation 512, the HLC 126 can then submit a goal option 424 to the LLC 122 which commences the LLC's 122 sampling of a historical experience trajectory 515.

In certain cases, this sampling can use the process for hindsight selection of goals covered in FIG. 6.

At the penultimate step of the episode, the LLC 122 might provide a condensed observation 514 that includes a history of observations to the HLC 126, at which point the HLC 126 will commence the online training protocol 501.

As another example, as the episode advances, the HLC 126 might receive early termination reasons for the goal option 424 it selected at the beginning of the episode as part of the condensed observation 514. Possible early termination reasons are covered in FIG. 6.

In some implementations, the LLC network 122 can also be frozen during the training of the HLC, such as if the high-level controller is being trained separately from the LLC. Keeping a neural network “frozen” during training refers to not passing gradients for updates, i.e., keeping the parameter values fixed while changing the parameter values of another neural network.

This example offline-online training system 500 can be deployed “at scale”, i.e. the system can be distributed over multiple agents and learners as prescribed by the IMPALA protocol.

In particular, the system 500 might be deployed such that the replay buffer 510 the LLC 122 samples from in the offline protocol 502 is being filled by one or more agents interacting in one or more environments.

Furthermore, the system 500 can be used to train a hierarchical controller 130 to be able to control an agent 104 to generalize to new industrial tasks that were not encountered during the training of the LLC 122, the HLC 126, or both. This is because the training system 500 promotes the training of a self-reliant agent 105 that can learn how to generate and use its own goal representations 124 from scratch using its own uncurated experience.

FIG. 6 is a block diagram of an example process 600 for the offline hindsight selection of goals using the LLC 122 given the online-offline training protocol 500 depicted in FIG. 5. For convenience, the process 600 will be described as being performed by a system of one or more computers located in one or more locations. For example, a training system, e.g., the training system 190 of FIG. 1, appropriately programmed, can perform the process 600.

In this case, the LLC 122 trains offline on multiple tasks sampled from the replay buffer 510. This multi-task training has the advantage of providing condensed observations to the HLC 126 that correspond with multiple goal representations 124, thereby guiding the HLC 126 learning of which options to select for the LLC 122 online. In particular, these condensed observations can include reasons for early termination of goals.

Specifically, the LLC 122 can sample a historical experience trajectory 515 from the observations logged in the replay buffer 510 and generates multiple tasks 610 from this sampled historical experience trajectory 515. These tasks 610 constitute segment subtrajectories, where each subtrajectory is a subset of the given observation 515 from start time tₛₜₐᵣₜ to end time t_{end}. It is typical for the goal to be fixed for the task, i.e., for the goal to be achieved at t_{end}.

By sampling multiple subtrajectories, the LLC 122 can be trained on multiple tasks 610 at once.

In particular, this pruning of the sampled historical experience trajectory 515 might be optimized in some way to aid the training of the LLC 122.

For example, task 610 creation might be enhanced to increase the frequency of segments that constitute non-zero rewards or to yield particular user-desired instances of tasks.

In some examples, non-goals, tasks that have no target goal state to be achieved, can also be included to bolster agent exploration.

In yet another example, tasks can be sampled randomly from the historical experience trajectory 515.

The LLC 122 then performs training over the multiple tasks 610 created by completing a loop through all the tasks 610 generated from the sampled historical experience 515.

In some cases, this loop over tasks can constitute a single episode of LLC 122 training.

In other cases, this loop over tasks can constitute a certain integer number of steps in the environment greater than or equal to one.

Within the loop, each task 610 serves as input to the goal encoder 408 and the value head 409.

The goal encoder 408 outputs a goal representation Gt 124 that is fixed for that sampled subtrajectory task 610. This output is then evaluated with the goal evaluators 406, specifically the goal attainment evaluator 406A and the similarity score calculator 406B.

If the goal 124 is determined to be too temporally too far off by the goal attainment evaluator 406A, an early termination reason can optionally be provided to the HLC 126 as part of a condensed observation 514.

In certain implementations, the goal attainment evaluator can be a classifier which learns a termination function directly.

If the goal 124 for the task 610 is determined to be too similar to other goals 124 in the episode by a distance similarity score calculator 406B, an early termination reason can optionally be provided to the HLC 126 as part of a condensed observation 514.

In certain implementations, the similarity score calculator 406B can be a distance metric such as cosine similarity that is evaluated to exclude from training all the goals that are up to a certain user-defined amount similar.

As an example, goals 124 which are greater than 60% similar according to this metric can be rejected from training.

For each task 610, the value estimate V^{LLC} from the value network 409 might be compared to a preset unreachability threshold value V_{unreachability threshold} using a value-based logic rule that rejects goals 124 for which the value is below the threshold.

If the value estimate is too low, the HLC 126 can receive an early termination reason specifying that the goal 124 was unattainable.

This threshold can be provided by the HLC 126 or set to a fixed value.

It is possible for other implementations to include early termination reasons not specified here that aid the ease of the LLC 122 training.

In the event that the task 610 was not rejected for any of the aforementioned early termination reasons, or any not aforementioned, training of the LLC 122 occurs.

Training can occur through any appropriate reinforcement learning method.

In particular, training can include the regularized offline V-Trace algorithm 620 described above.

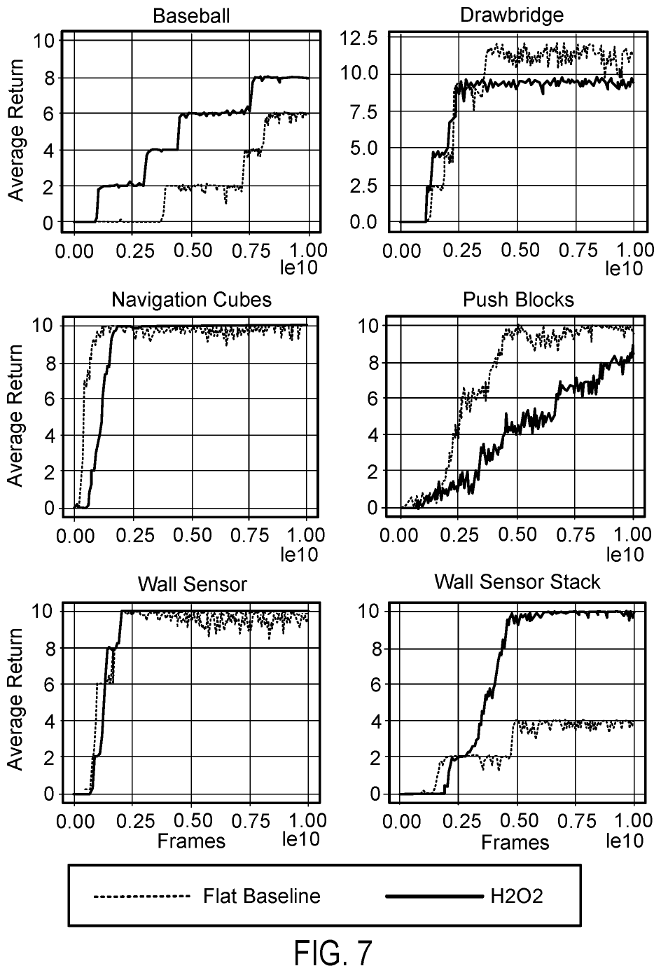

FIG. 7 shows the performance of the offline-online hierarchical system of FIGS. 5 and 6 (H2O2) using average episode return per different tasks taken from the DeepMind Hard Eight suite of tasks as compared with a state-of-the-art flat agent baseline.

FIG. 7 shows six plots that correspond to a subset of six tasks from the DeepMind Hard Eight suite of tasks: baseball, drawbridge, navigation cubes, push blocks, wall sensor, and wall sensor stack tasks. These tasks constitute tasks in visually complex partially observable 3D environments, which was previously a challenge for hierarchical agents.

Results are excluded for the throw across and remember sensor tasks because neither agent made progress on these tasks during testing.

The agent trained with the hierarchical training system described performs better than or comparably to the other agent in the majority of the tasks. In particular, H2O2 achieves better results in the baseball, wall sensor, and just as well in the navigation cubes task.

Despite not achieving better results in the drawbridge or push blocks task, H2O2 is still competitive with the state-of-the-art flat agent baseline, representing a tackling of previous challenges in hierarchical reinforcement learning, such as demonstrating performance comparable to other flat (non-hierarchical) techniques in visually complex partially observable 3D environments.

In practice, the reason why the hierarchical agent might have performed worse than the flat baseline on these two tasks might be because the design of the LLC effectively changes the semi-Markov Decision Process (SMDP) experienced by the HLC. A hierarchical agent can only be competitive with a flat agent if the SMDP is easier to solve than the original Markov Decision Process (MDP) of the task.

Additionally, FIG. 7 is significant as H2O2 performance came from learning goal representation behaviors offline from any experience generated by an agent instead of relying on an expert agent curated dataset.

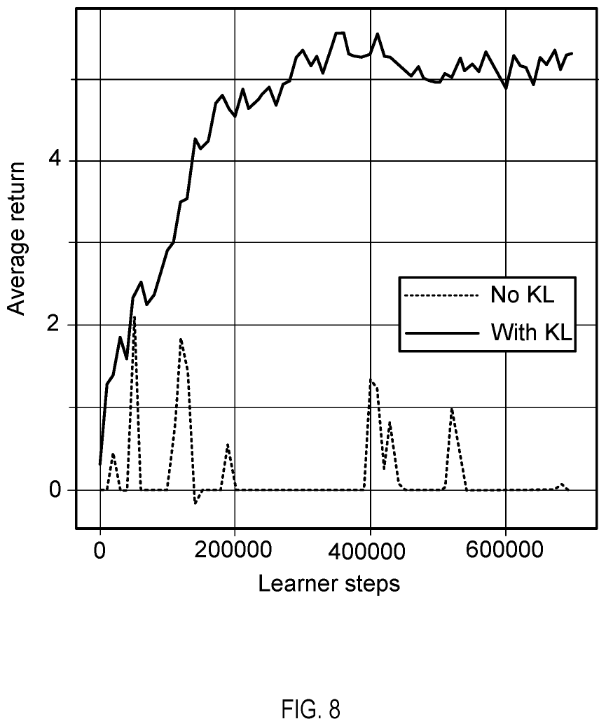

In FIG. 8, the power of including the KL regularization term in the modified V-Trace algorithm is demonstrated in the case of the H2O2 offline-online implementation for an example task. For this example task, removing the penalty allows the learned policy to deviate too far from the behavior policy and therefore resulted in substantially worse performance.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for controlling an agent interacting with an environment to perform a task, the method comprising:
at each of a plurality of first time steps from a plurality of time steps:
receiving an observation characterizing a state of the environment at the first time step;
determining a goal representation for the first time step that characterizes a goal state of the environment to be reached by the agent, wherein determining the goal representation comprises:
determining whether criteria for generating a new goal representation are satisfied at the first time step;
in response to determining that the criteria for generating the new goal representation are satisfied:
generating a high-level observation for the first time step;
processing a high-level input that comprises the high-level observation using a high-level controller neural network to generate a high-level policy output that comprises a goal output characterizing the goal state and an indication of whether to (i) control the agent using a low-level controller or (ii) control the agent using a primitive action identified by the high-level policy output;
determining, based on the indication of whether to (i) control the agent using the low-level controller or (ii) control the agent using a primitive action identified by the high-level policy output, to control the agent using the low-level controller; and
in response, processing the observation and the goal representation using a low-level controller neural network to generate a low-level policy output that defines an action to be performed by the agent in response to the observation; and
controlling the agent using the low-level policy output.

2. The method of claim 1, further comprising:
in response to determining that the criteria for generating the new goal representation are not satisfied, using, as the goal representation for the first time step, a goal representation from a preceding first time step.

3. The method of claim 1, further comprising, in response to determining that the criteria for generating the new goal representation are satisfied:
processing the goal output using a goal encoder neural network to generate the goal representation.

4. (canceled)

5. The method of claim 1, further comprising, at each of one or more second time steps from the plurality of time steps:
generating a high-level observation for the second time step;
processing a high-level observation for the second time step using the high-level controller neural network to generate a high-level policy output for the second time step;
determining, based on the indication of whether to (i) control the agent using the low-level controller or (ii) control the agent using a primitive action identified by the high-level policy output, to control the agent using the primitive action identified by the high-level policy output; and
in response, controlling the agent using the primitive action identified by the high-level policy output.

6. The method of claim 1, wherein the high-level observation for the first time step comprises one or more of the observation received at the first time step, data identifying a number of time steps since a most recent time step at which the criteria were satisfied, data characterizing rewards received from the environment since a most recent time step at which the criteria were satisfied, or data characterizing observations received at time steps since a most recent time step at which the criteria were satisfied.

7. (canceled)

8. (canceled)

9. (canceled)

10. The method of claim 1, wherein the criteria are satisfied when any criterion in a set of criteria are satisfied, and wherein the high-level observation for the first time step comprises:
data identifying which criterion was satisfied at the first time step.

11. (canceled)

12. (canceled)

13. The method of claim 1, wherein the high-level policy output comprises a hyperparameter that defines some aspect of training, and wherein controlling the agent using the low-level policy output comprises:
applying the hyperparameter to the low-level policy output to generate an adjusted policy output; and
selecting an action using the adjusted policy output.

14. (canceled)

15. The method of claim 1, wherein:
determining whether criteria for generating the new goal representation are satisfied at the first time step comprises:
determining that the criteria for generating a new goal representation are satisfied when the first time step is an initial time step in a task episode; or
determining that a maximum number of time steps have elapsed since a most recent time step at which the criteria were satisfied.

16. (canceled)

17. The method of claim 1, wherein the low-level controller neural network comprises:
a representation neural network configured to process the observation to generate an internal state representation of the observation, and
a low-level policy head configured to process the state observation representation and the goal representation to generate the low-level policy output; and
a value head configured to process the observation representation and the goal representation to generate a value estimate of a value of the environment being in the state characterized by the observation to reaching the goal state characterized by the goal representation.

18. The method of claim 17, wherein
determining whether criteria for generating the new goal representation are satisfied at the first time step comprises:
determining that the criteria for generating the new goal representation are satisfied when the value estimate generated by the value head by processing an observation representation of an observation at a preceding time step and a goal representation for the preceding time step is below an unreachability threshold value.

19. The method of claim 17, wherein:
determining whether criteria for generating the new goal representation are satisfied at the first time step comprises:
determining that the criteria for generating the new goal representation are satisfied when the value estimate generated by the value head by processing an observation representation of an observation at a preceding time step and a goal representation for the preceding time step is above an attained threshold value that indicates that the goal characterized by the goal representation for the preceding time step has been attained.

20. The method of claim 19, wherein the attained threshold value is included in the high-level policy output.

21. The method of claim 1, wherein
determining whether criteria for generating the new goal representation are satisfied at the first time step comprises:
processing a classifier input characterizing (i) an observation at a preceding time step and (ii) a goal state for the preceding time step using a classifier neural network to generate a classifier output that indicates how many time steps remain until the goal state is attained; and
determining that the criteria for generating a new goal representation are satisfied when the classification output indicates that zero time steps remain until the goal state is attained.

22. A The method of claim 1, wherein the low-level controller neural network has been trained by performing operations comprising:
obtaining one or more trajectories of observation-action pairs and, for each trajectory, a respective goal;
for each trajectory, generating a respective reward for each pair in the trajectory based on whether the goal was attained in the state characterized by the observation in the pair; and
training the low-level controller neural network on the one or more trajectories and the one or more rewards to optimize a reinforcement learning objective that comprises a proximity regularization term that penalizes low-level policy outputs generated by the low-level controller neural network from diverging from behavior cloning policy outputs generated by a behavior cloning head that is (i) trained on a behavior cloning loss and (ii) configured to, for a given observation and given goal representation, process a given observation representation for the given observation generated by the representation neural network and the given goal representation to generate a behavior cloning policy output for the observation.

23. The method of claim 22, wherein the behavior cloning policy outputs and the low-level policy outputs each define a probability distribution over actions, and wherein the proximity regularization term is based on, for each observation in each trajectory, a divergence between (i) a low-level policy output generated by the low-level policy head by processing an observation representation of the observation generated by the representation neural network and a goal representation of the goal for the trajectory and (ii) a behavior cloning policy output generated by the behavior cloning policy head by processing the observation representation of the observation generated by the representation neural network and the goal representation of the goal for the trajectory.

24. (canceled)

25. The method of claim 23, wherein the reinforcement learning objective further comprises a term that, for each observation-action pair in each trajectory, is a product of (i) a term that is based on the reward for the pair and (ii) a ratio between (a) a probability assigned to the action in the pair by the low-level policy output generated by the low-level policy head by processing an observation representation of the observation generated by the representation neural network and a goal representation of the goal for the trajectory and (b) a probability assigned to the action in the pair by the behavior cloning policy output generated by the behavior cloning policy head by processing the observation representation of the observation generated by the representation neural network and the goal representation of the goal for the trajectory.

26. The method of claim 25, wherein the term that is based on the reward for the pair is a V-Trace policy gradient term.

27. The method of claim 22, further comprising:
training the behavior cloning policy head and the representation neural network on the one or more trajectories to minimize the behavior cloning loss.

28. (canceled)

29. (canceled)

30. The method of claim 22, wherein the one or more trajectories are sampled from off-line data generated while the agent was controlled by one or more different behavior policies.

31. (canceled)

32. The method of claim 30, wherein the low-level controller is trained both on the off-line data and on-line data generated by controlling the agent using low-level policy outputs generated by the low-level controller.

33. The method of claim 22, wherein the high-level observation is processed using a high-level controller network to generate a high-level policy output, and further comprising:
training the high-level controller neural network through reinforcement learning to maximize expected rewards for the task generated as a result of controlling the agent based on high-level policy outputs generated by the high-level controller neural network and low-level policy outputs generated by the low-level controller neural network.

34. The method of claim 33, wherein no gradients are passed to the low-level controller neural network as a result of the training of the high-level controller neural network.

35. The method of claim 33, wherein the one or more trajectories include one or more trajectories that are sampled from on-line data generated while controlling the agent during the training of the high-level controller.

36. The method of claim 33, wherein the one or more trajectories do not include any trajectories that are sampled from on-line data generated while controlling the agent during the training of the high-level controller.

37. The method of claim 23, wherein the reinforcement learning objective comprises one or more auxiliary loss terms, wherein each auxiliary loss term corresponds to a respective auxiliary task, and wherein each of the auxiliary tasks requires generating a prediction characterizing a distribution of goals conditioned on an output generated by the representation neural network.

38. The method of claim 23, further comprising generating, for each of the one or more trajectories of observation-action pairs, a respective goal, the generating comprising, for one or more of the trajectories:
selecting a goal describing a state of the environment characterized by the last observation in the trajectory.

39. The method of claim 23, further comprising generating, for each of the one or more trajectories of observation-action pairs, a respective goal, the generating comprising, for one or more of the trajectories:
selecting a goal describing a state of the environment that is not characterized by any of the observations in the trajectory.

40. The method of claim 1, wherein the agent is a mechanical agent and the environment is a real-world environment.

41. (canceled)

42. (canceled)

43. (canceled)

44. A system comprising:
one or more computers; and
one or more storage devices communicatively coupled to the one or more computers, wherein the one or more storage devices store instructions that, when executed by the one or more computers, cause the one or more computers to perform operations for controlling an agent interacting with an environment to perform a task, the operations comprising:
at each of a plurality of first time steps from a plurality of time steps:
receiving an observation characterizing a state of the environment at the first time step;
determining a goal representation for the first time step that characterizes a goal state of the environment to be reached by the agent, wherein determining the goal representation comprises:
determining whether criteria for generating a new goal representation are satisfied at the first time step;
in response to determining that the criteria for generating the new goal representation are satisfied:
generating a high-level observation for the first time step;
processing a high-level input that comprises the high-level observation using a high-level controller neural network to generate a high-level policy output that comprises a goal output characterizing the goal state and an indication of whether to (i) control the agent using a low-level controller or (ii) control the agent using a primitive action identified by the high-level policy output;
determining, based on the indication of whether to (i) control the agent using the low-level controller or (ii) control the agent using a primitive action identified by the high-level policy output, to control the agent using the low-level controller; and
in response, processing the observation and the goal representation using a low-level controller neural network to generate a low-level policy output that defines an action to be performed by the agent in response to the observation; and
controlling the agent using the low-level policy output

45. One or more non-transitory computer storage media storing instructions that when executed by one or more computers cause the one or more computers to perform operations for controlling an agent interacting with an environment to perform a task, the operations comprising:
at each of a plurality of first time steps from a plurality of time steps:
receiving an observation characterizing a state of the environment at the first time step;
determining a goal representation for the first time step that characterizes a goal state of the environment to be reached by the agent, wherein determining the goal representation comprises:
determining whether criteria for generating a new goal representation are satisfied at the first time step;
in response to determining that the criteria for generating the new goal representation are satisfied:
generating a high-level observation for the first time step;
processing a high-level input that comprises the high-level observation using a high-level controller neural network to generate a high-level policy output that comprises a goal output characterizing the goal state and an indication of whether to (i) control the agent using a low-level controller or (ii) control the agent using a primitive action identified by the high-level policy output;
determining, based on the indication of whether to (i) control the agent using the low-level controller or (ii) control the agent using a primitive action identified by the high-level policy output, to control the agent using the low-level controller; and
in response, processing the observation and the goal representation using a low-level controller neural network to generate a low-level policy output that defines an action to be performed by the agent in response to the observation; and
controlling the agent using the low-level policy output
